(19) United States
(12) Patent Application Publication
(10) Pub. No.: US 2007/0271896 A1
(43) Pub. Date: Nov. 29, 2007

(54) Leaf Stripper

(76) Inventors: Philippe Bonny, Estavayer-le-Lac (CH); Alexandre Singy, Estavayer-le-Lac (CH)

Correspondence Address: POWER DEL VALLE LLP, 233 WEST 72 STREET, NEW YORK, NY, 10023, US

(21) Appl. No.: 10/599,033

(22) PCT Filed: Mar. 17, 2005
(86) PCT No.: PCT/CH05/00160

§ 371 Date: Oct. 26, 2006

(30) Foreign Application Priority Data
Mar. 17, 2004 (CH) 451/04

(51) Int. Cl. A01D 23/02

(52) U.S. Cl. 56/121.4

(57) ABSTRACT

The invention relates to a leaf stripper comprising a frame (1) which is equipped with a circular housing (9) in which a cutter blade (5) and a blade turbine (10) are rotation mounted to a shaft (6) which is in turn driven by a motor (7). In addition, an apertured plate (3), which is equipped with parallel openings (4), is mounted on the frame and the cutter blade. Moreover, a suction device (15) is mounted to a sleeve (11) which is mounted on the side of the frame. According to the invention, the plant to be stripped is positioned on the apertured plate during the leaf stripping operation.

This invention relates to a leaf stripper machine, particularly a machine with a grill, a rotating blade and a turbine, which are used to strip leaves from plants.

In the field of medicinal plant cultivation, only one part of the plant contains substances with special qualities that can be used in preparations. In the vast majority of cases, it is the central part of the plant that contains these substances and while harvesting it becomes necessary to remove all the leaves or other plant parts that are around the central part of the plant to preserve only the central part in as pure a state as possible.

Most often, for quality reasons, it is important that the leaf stripping be done at harvest time, therefore generally right on the spot. Currently, leaf stripping is done by hand, which requires a lot of labor. These operations are expensive and their quality depends on the skills of the persons responsible for this job.

Therefore, it became apparent that mechanized leaf stripping needed for these particular plants would have several advantages.

The known methods of executing this operation were tried but they have numerous disadvantages. The main disadvantage of these methods is the lack of precision, which means either there are too many unwanted substances or there is a percentage of loss of useful parts. Furthermore, the known methods gather waste, which is not easily used in all the cases. The known methods of execution also have the disadvantage of having less capacity as compared to their design. Since these machines are meant to be transported to the place of harvest, they must have a high yield/size ratio, which is not the case with the known methods.

Moreover, the known methods are expensive and can only be used when mounted on agricultural machines that are very expensive too.

The objectives of this invention are to remedy the disadvantages of the known methods.

The objectives are achieved by the invention principles as defined in claim 1.

As per the invention principle, the leaf stripper has a plate that is mounted on a frame, the plate has openings or grilled parts in relief and they can be used as a guide by means of the openings made on a higher plate. A blade is mounted rotating directly under the pierced higher plate under the grill and is activated by a motor, which in turn activates a turbine placed between the two. This method of execution has several advantages. It allows you to control the leaf stripping with high precision. In fact, on the one hand, the leaf cutting distance or other parts to be removed is constant, which is a major advantage and on the other hand, the central part of the plant cannot be altered under any circumstances during leaf stripping. Therefore, the quality of the usable part is guaranteed and so is the quantity, as the invention's principles help avoid loss of a percentage of the usable part. The leaves are cut, suctioned and blown by the turbine. This waste can therefore be very easily packaged and used as the case may be; this is another advantage regarding the waste, which is presented homogenously.

Another advantage of this invention principle is the small size and its lightness which, coupled with large capacity, allows for easy transport and movement of the leaf stripper to different places of harvest. The leaf stripper can also be moved easily by hand.

It is also made of parts that are easily available and thus less expensive.

The designs attached hereto illustrate the invention principles systematically.

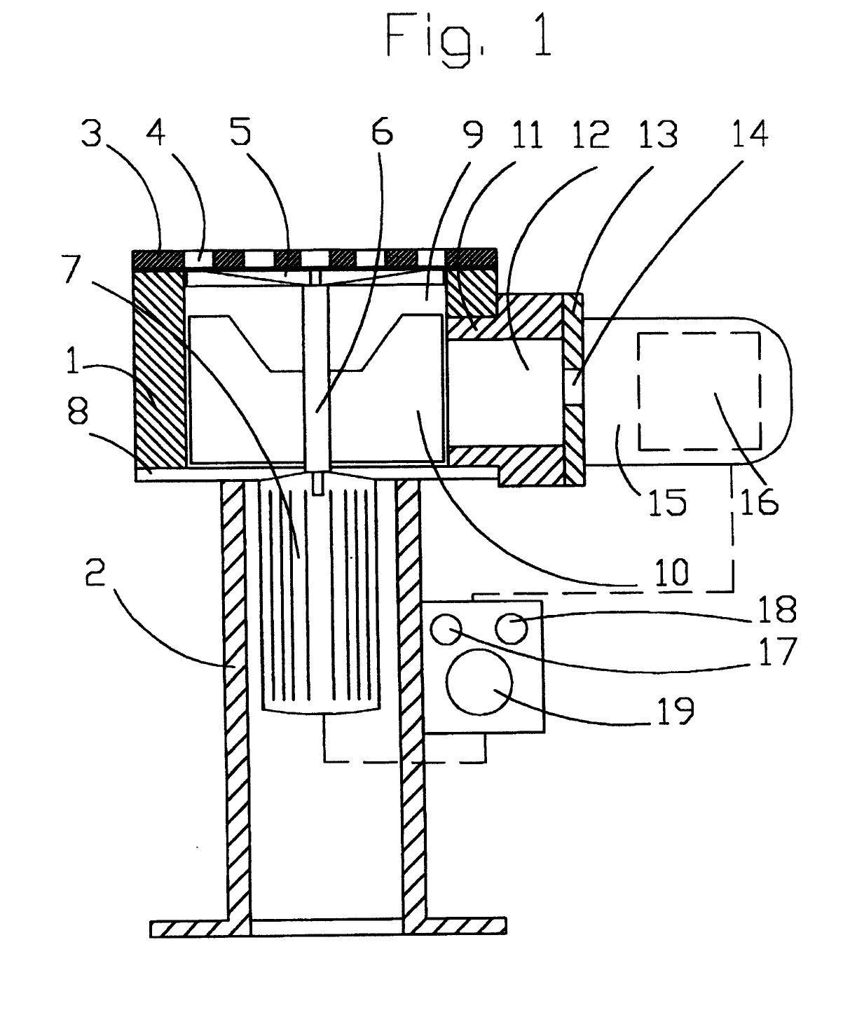

FIG. 1 is a view of the entire front face of the leaf stripper.

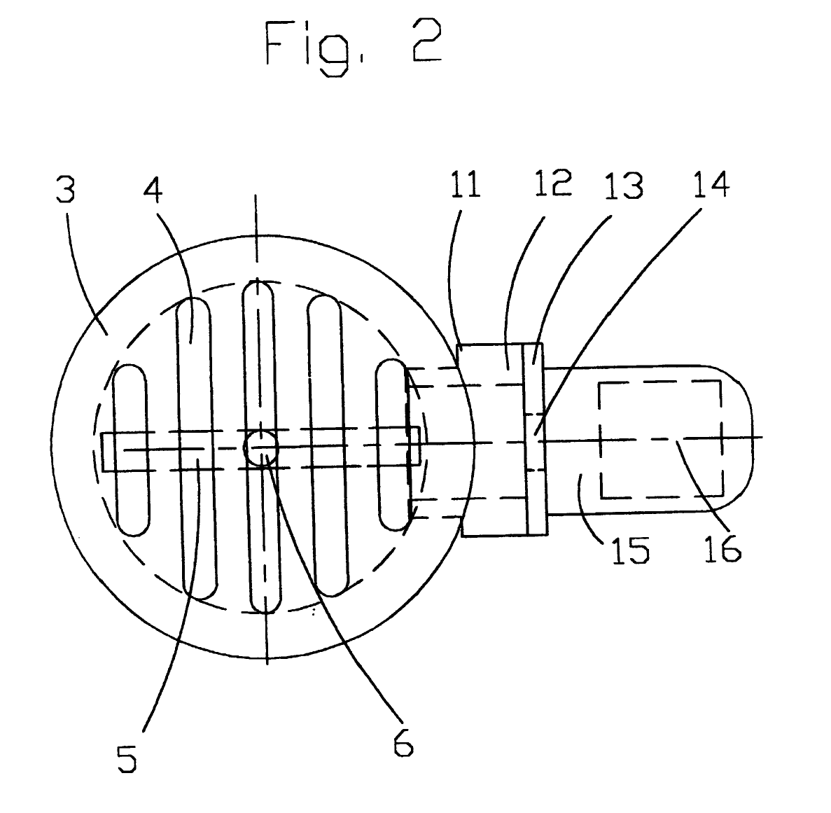

FIG. 2 is top view of the leaf stripper with an apertured plate.

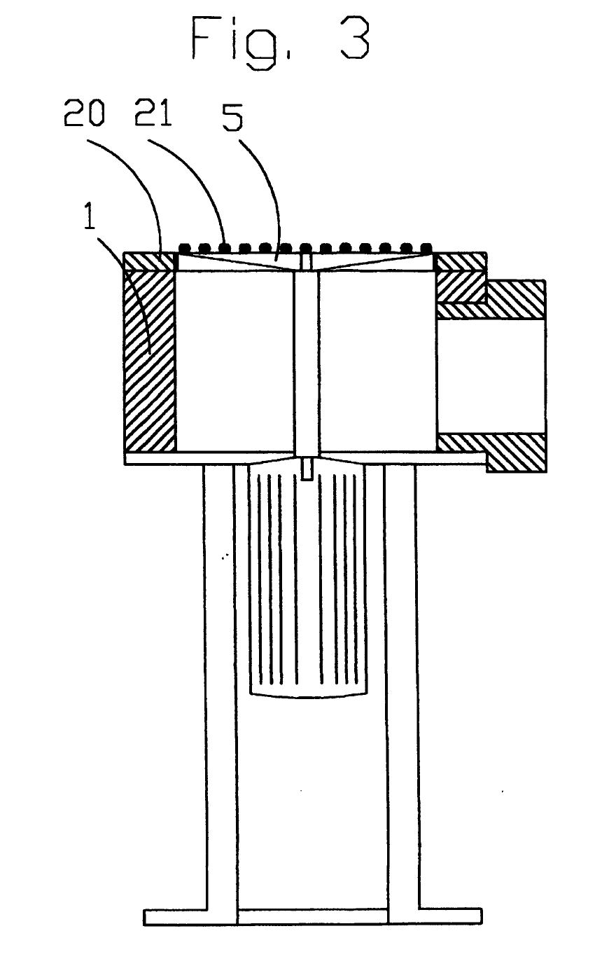

FIG. 3 is a front view of a method of execution with a grill in relief.

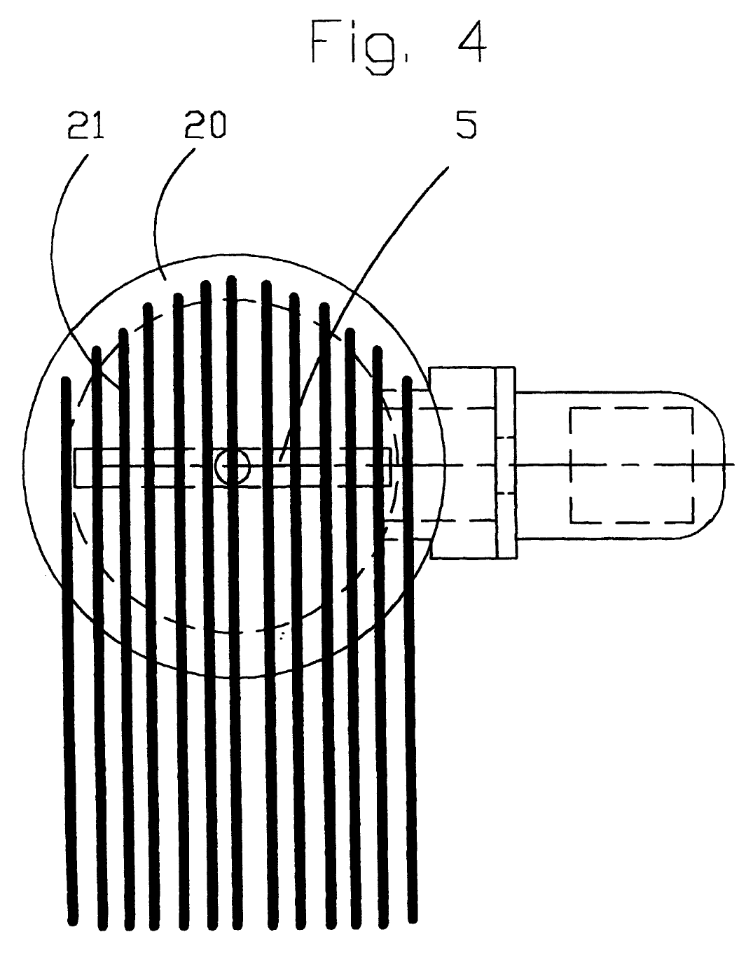

FIG. 4 is a top view of the method of execution with a grill in relief.

With reference firstly to FIGS. 1 and 2, the leaf stripper has a frame 1, which is mounted on a base. An apertured plate 3 is fixed to the upper part of the frame 1 and has openings 4. The number of openings could vary. The openings are mounted parallel in FIG. 1.

A blade 5 is mounted under the apertured plate 3. The blade 5 is activated by a motor 7 by a shaft 6. A blade turbine 10 is mounted on the shaft 6 and is fitted in a circular housing 9. For example, the blade turbine can also be made of a fan propeller. The motor 7 is fixed on a base plate 8, which is fixed under the frame 1. A sleeve 11 with an exit opening 12 is mounted on the side and inside the frame 1. An end shield 13 with an opening 14 is fixed to the sleeve 11. A suction device 15 with an end piece is mounted in the opening 14. The suction device 15 has a bag 16 to collect the leaves from the plant. A command box is connected to the motor and to the suction device and has a start button 17, a trigger button 18 and a safety button 19. The safety button 19 can be activated by pressure, for example, by pressure from the knee or the leg of the user.

In practice, the leaf stripper is positioned on the apertured plate and moved in the direction of the plate's apertures, which has a grill with straight openings for leaf stripping, and the plant is rotated during this operation to collect all the leaves.

FIGS. 3 and 4 show a method of execution using a grill 20 mounted on the frame 1 with rods 21 fixed on the upper part as relief guide. The grill and the openings as shown in FIGS. 1 and 2 can also be obtained by grooves and ribs for relief. The blade 5 is mounted directly under the grill.

FIG. 4 shows that the rods 21 are longer on the side facing the leaf stripper at the place where the plants are positioned on the grill. This longer length allows you to get better introductory guidance to the leaves for certain kind of plants.

In practice, the plant is cut and can be stripped directly without another operation.

1. Leaf stripper with a frame (1) having a circular housing (9) inside which a blade turbine (10) and a blade (5) are mounted rotating on a shaft (6) which is connected to a motor (7), characterized by an apertured plate (3) with openings (4) is mounted on the upper part of the frame and on the blade, the plant to be stripped is positioned on the apertured plate during leaf stripping through the sleeve (11) with an exit opening (12), mounted on the side of the frame and that a suction device (15) is mounted on the sleeve.

2. Leaf stripper, as per claim 1, characterized by an apertured plate that has straight rods, which forms a grill and whose rods are longer on one side in order to act as a guide for the plant to be leaf stripped.

3. Leaf stripper, as per claim 1, characterized by an apertured plate that has parallel openings.

4. Leaf stripper, as per claim 1, characterized by an apertured plate that has guiding grooves and ribs.
